(19) United States
(12) Patent Application Publication
(10) Pub. No.: US 2017/0249360 A1
(43) Pub. Date: Aug. 31, 2017

(54) SKEW SENSITIVE ESTIMATING OF RECORD CARDINALITY OF A JOIN PREDICATE FOR RDBMS QUERY OPTIMIZER ACCESS PATH SELECTION

(71) Applicant: INTERNATIONAL BUSINESS MACHINES CORPORATION, Armonk, NY (US)

(72) Inventors: JASON L. ALPERS, LEE'S SUMMIT, MO (US); TERENCE P. PURCELL, SPRINGFIELD, IL (US); Patrick D. Bossman, Sarasota, FL (US)

(21) Appl. No.: 15/054,684

(22) Filed: Feb. 26, 2016

(51) Int. Cl. G06F 17/30

(52) U.S. Cl. CPC G06F 17/30469; G06F 17/30466

(57) ABSTRACT

A query optimizer receives a relational database management system (RDBMS) query having a join predicate with a join between a first and a second table. The query optimizer determines a high skew value for a first variable joining the first and second tables at columns per the join predicate. A count query on one of the first and second tables is constructed and run only using the high skew value as a substitution for the first variable. A quantity of records for the join of the first and second tables is estimated using results of the count query. Different access paths (e.g., query plans) are used by the query optimizer depending on whether the estimated quantity of records exceeds a previously determined threshold or not.

### BACKGROUND

The present invention relates to the field of database query optimization and, more particularly, to skew sensitive estimating of record cardinality of a join predicate for optimizer access path (e.g., query plan) selection.

A relational database management system (RDBMS) utilizes a query optimizer to determine whether executing a structure queried language (SQL) query is faster using one possible access path (e.g., query plan) verses another. Two access paths available to a query optimizer that produces equivalent results include a table scan access path and an index access path. In a table scan, the query optimizer sequentially reads all rows of a table and compares each row with the search criteria in the WHERE clause, which is called a predicate in a SQL query. In an index access path a query, an indexed column is sorted and used to resolve the SQL query. Generally, when a number of records being considered is high, the table scan access path is faster and when the number of rows is relatively small, it is much faster to resolve a SQL query using the sorted row based on the index (as opposed to sequentially scanning an entire table). The above is accurate, but simplified as the query optimizer considers index access when a column index (clustered or non-clustered) exists and the decision about whether to use the existing index (e.g., the index access path) depends on many different factors. The access paths detailed herein need not be related to a table scan verses an index access path.

Record skew affects the selection of which access path a query optimizer utilizes. Record skew is a measurement of asymmetry within a distribution of data in a table. Another related term is “selectivity” which is the measure of the filtering in that a query is highly selective if it results in a minimal number of records being returned and has low selectively if it results in a large quantity of records being returned. Skew and selectively require knowledge about the underlying nature of data records in an RDBMS database.

Implementations of database optimizers typically perform access path selection before the search values are known, which means that a SQL query with a predicate (e.g., Where clause) that joins tables may have an unknown cardinality on the join predicate. In other words, although the query optimizer may be aware of a first quantity of records in table one, and of a second quantity of records in table two, when table one and two are joined (such as by limiting the records to only those having a column one value on table one that equals a column two value on table two), query optimizers typically lack information on the quantity of records involved (it is unaware of the number of records contained in the filtered result containing only records having Col1 and Col2 values between the tables being equal). A database optimizer therefore often defaults to the assumption that all values are evenly distributed throughout each table. In many instances a query optimizer's use of a default results in a non-optimized access path, effectively causing the query optimizer to fail in its optimizing function when a join predicate is used in a SQL query.

Existing solutions to the above known problem, introduce substantial manual and/or computing overhead. For example, one solution is to include tooling within the database management system that samples queries in a live database and overtime develops statistics to train the optimizer for greater selection of an access path. This tooling, however, increases computational latency on queries in general, which offsets any optimization gains in many instances and increases latencies especially for short running queries. Another solution sometimes used is performance tuning using join indexes, which is a time consuming optimization that requires manual effort and time of a database professional. In short, as conventionally implemented, constructing, organizing, and maintaining statistic views and/or join indexes for databases is a costly, non-trivial investment that may mitigate some issues with query optimizations to handle join skew issues, but that always increases cost/overhead and that often results in marginal or no performance gains relative to the necessary overhead involved. Further, the manual tweaking of database(s) for query optimization (such as using performance sampling, statistics views, and join indexes) is a disfavored step requiring substantial knowledge of underlying data records, which is not able to be implemented as an “out of the box” solution. Customers increasingly expect ideal (or near ideal) performance in an “out of the box” database system that does not require pre-configuration, extensive tuning, and tuning expertise specific to a company's underlying data records (which includes real issues of skew-ness of the data in tables, which requires live representative data at a minimum). What is needed, and presented within the present disclosure, is an improvement to query optimizers to improve performance of join predicates, which is sensitive to skew and that does not require extensive manual tuning (or performance decreasing sampling/automated learning).

### BRIEF SUMMARY

One aspect of the present invention can include a system, a computer program product for skew-sensitive query optimization across join predicates in a relational database management system (RDMBS). In this aspect, a RDBMS query can be received at a query optimizer. The RDBMS query has a join predicate with a join between a first and a second table. A cardinality of resulting rows from the join predicate is unknown to the query optimizer initially, which triggers default behavior in absence of join predicate cardinality information. The query opthnizer determines a high skew value for a column of one table referenced in the join predicate. A count query is automatically constructed and run on one of the tables (only). For example, the count query can be local to the second table, where a column of the second table is equal to the high skew value (determined from the first table). A quantity of records for the join of the first and second tables is estimated given the join predicate using results of the count query. If the estimated quantity of records is greater than a previously determined threshold, the query optimizer optimizes the RDBMS query using a first access path. If the estimated quantity of records is not greater than a previously determined threshold, the query optimizer optimizes the RDBMS query using a second access path. The first access path and the second access path produce functionally equivalent results while having disparate computational speeds to produce the equivalent results. An access path used by the query optimizer responsive to comparing of the estimated quantity of records to the previously determined threshold is computationally faster than default behavior of the query optimizer.

### BRIEF DESCRIPTION OF THE SEVERAL VIEWS OF THE DRAWINGS

FIG. 1 shows a diagram within which a query optimizer is sensitive to skew occurring within a join predicate in accordance with an embodiment of the disclosure.

FIG. 2 shows a flow chart for a process for query optimization sensitive to join skew in accordance with an embodiment of the disclosure.

FIG. 3 shows a system where query optimization sensitive to join skew in accordance with an embodiment of the disclosure.

### DETAILED DESCRIPTION

Embodiments of the disclosure compute an estimate of records returned for a join predicate to estimate selectively (i.e., inverse of amount of record skew) during query optimization. A join between two tables can be modified to be a local predicate for a selectively estimate of the join predicate. The join of the non-local table can be at a column having a record skew (or the skew can be on the local table), which is a skew that is conventionally masked as a database management system (and query optimizer) typically lacks join predicate selectively information. Using a local table estimate (e.g., a count query where a high skew value substitutes for a non-local table variable at a join predicate), improved performance for a query optimizer is obtained without requiring pre-configuration or tuning expertise and without having an appreciable impact (minimal to no impact) on query execution. Instead, a onetime small overhead for query optimization is performed. Thus, embodiments of the disclosure improves query optimization in an RDBMS by estimating the selectively information of the join predicate.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

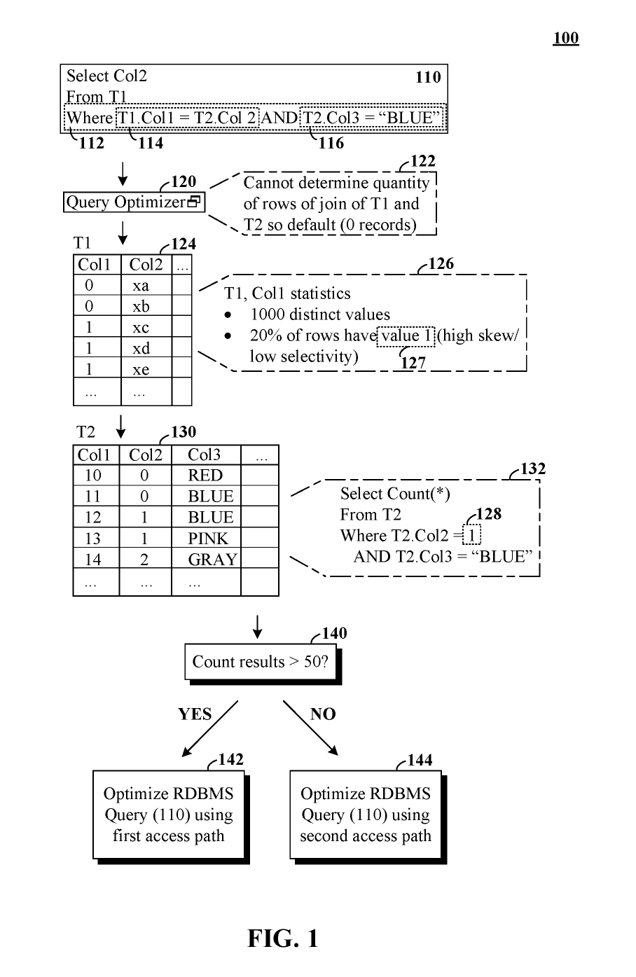

FIG. 1 shows a diagram 100 within which a query optimizer 120 is sensitive to skew occurring within a join predicate in accordance with an embodiment of the disclosure. In diagram 100, a relational database management system (RDBMS) is provided with a structure query language (SQL) statement 110. The SQL statement 110 includes a predicate 112 (referred to as a join predicate) with a table join 114 and a column of one of the tables constrained to a variable 116. As shown, the SQL statement 110 is a select statement; the table join 114 joins a table referred to as T1 with a table referenced as T2. The table structure 124 for T1 includes at least two columns (e.g., Col1, Col2). The table structure 130 for T2 includes at least three columns (e.g., Col1, Col2, Col3). In FIG. 1 the SQL statement 110 join 114 specifies that T1.Col1=T2.Col2. Additionally, variable 116 specifies T2.Col3 equals the value “BLUE.”

When the query optimizer 120 analyzes the SQL statement 110, it cannot determine a quantity of rows of the join predicate 112 based on information initially available to the query optimizer 120, as indicated by item 122. A default access path is established by the query optimizer 120 in absence of additional information being determined and made available. For example, the default can assume the join predicate 112 is evenly distributed throughout the joined table. Item 122 does not imply that no statistical information concerning tables T1 and T2 are available just that no proper information for the join predicate 112 exists. In one embodiment, T1 statistics 126 can be available. These statistics 126, as shown, indicate one thousand distinct values for Col1 are present, but that twenty percent of the rows (e.g., records) have a value of “1” for T1.Col1. The statistics 126 of T1 do not provide the query optimizer 120 with information related to a record quantity of the join predicate 112. Therefore, the query optimizer will assume that each value exists 1/1000 times—since there are 1000 distinct values, and each join is searching for one of those 1000 values.

Diagram 100 estimates the join predicate record return by conducting a query localized to T2 (or to one of the tables of the join predicate). This is accomplished by acquiring a record count for a number of records within T2 having columns equal to set values. One of these values (high skew value 128) corresponds to the high skew value 127. That is, the join 114 columns of table 1 and table 2 are considered, where a value is selected having a high skew at the join column. A count query 132 is conducted local to table two (T2) where the T2.Col1 is set to the high skew value 127, and where any other local variables (T2.C3) are set to the proper values consistent with the SQL query 110.

After the SQL count query 132 is executed to estimate the join predicate 120 record quantity, the estimated number of records can be compared against a predefined quantity (e.g., a threshold), as shown by decision block 140. As shown, the count results (from query 132) are compared against a threshold value of fifty. If the estimate is greater than the threshold, the query optimizer executes (142) an access path for the SQL query 110, which is designed to handle a relatively large number of records (in the join predicate 120) in an optimal manner. In embodiments, the relatively high records can result from a high skew (using the value of “1”, which represent 20 percent of the rows from T1.Col1 per statistics 126) which cannot be determined without the estimate from the records returned from the table join 114 further conditioned by a table two column equaling a value (116). If the count result does not exceed the threshold (in decision block 140), the query optimizer 120 can optimize the RDBMS query 110 using a different access path, as shown by block 144.

Diagram 100 shows an approach where a high-skew value 127 of one table (T1) is utilized to estimate a quantity of records present in the join 114. By its nature use of such a high-skew value 127 will produce a high-side estimate of the record count resulting from the join predicate, thus diagram 100 shows an estimate for a join predicate 112 intentionally biased to default to a high skew access path. This intentional bias can be inconsistent with the default behavior (e.g., the query optimizer 120 defaults to an access path in this case for a high quantity of records due to the high skew rather than an even distribution). In other embodiments (where different defaults are used by a query optimizer 120), a different bias (for the estimate) can be established. Embodiments are contemplated where a different bias (such as a medium bias) is contemplated for the estimate and the disclosure is not limited to use of a high skew value 128. Significantly, the count query 132 used to generate the estimate is based on a local query, which is able to be rapidly executed with minimal overhead. Unlike conventional solutions, the one detailed in diagram 100 does not require pre-configuration/tuning before effective use. Further, no significant degradation of query execution time is experienced (the estimate can be computed and stored using a one-time small overhead query optimization as described). In situations where short running queries are prevalent in the RDBMS, the small (to no) overhead advantage of the disclosed approach (verses a statistical sampling approach or other learning algorithm that requires runtime tooling that degrades performance of runtime queries during the learning process as a computational overhead cost).

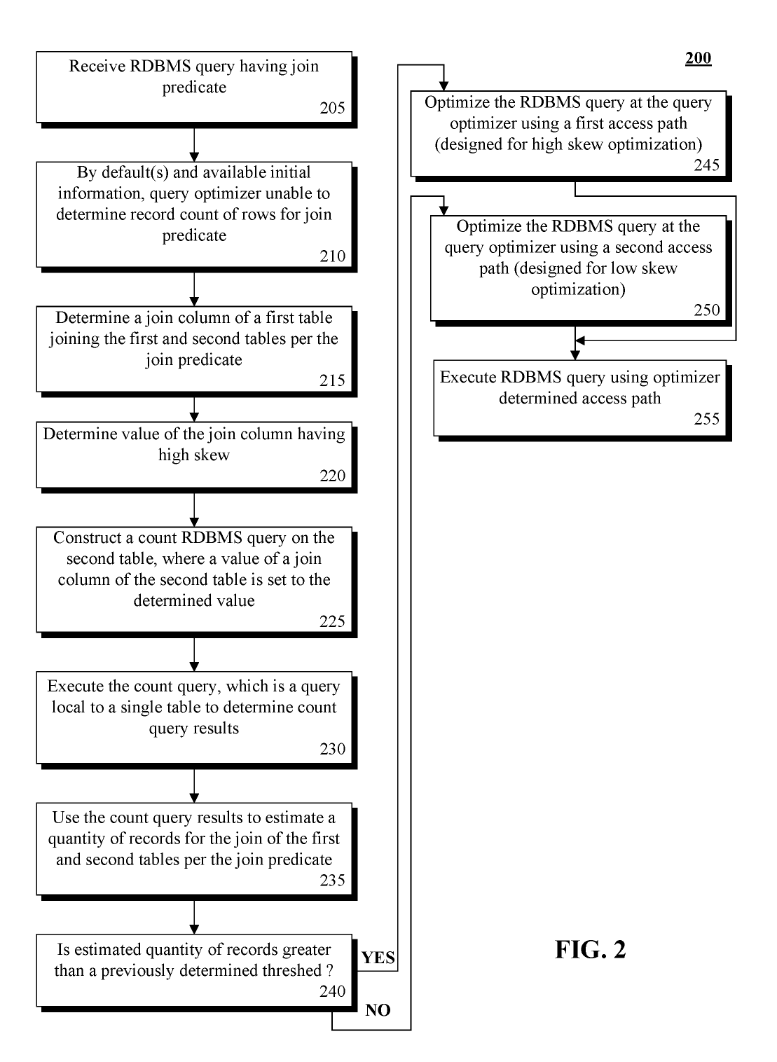

FIG. 2 shows a flow chart 200 for a process for query optimization sensitive to join skew in accordance with an embodiment of the disclosure. In step 205, an RDBMS query can be received by an RDBMS, where the RDBMS query includes a join predicate. By default, as shown by step 210, a query optimizer of the RDBMS initially lacks information to determine or realistically estimate a record count for rows resulting from the join predicate. Thus, a default behavior (commonly setting the record count of the join predicate to be 1a/column cardinality) of a query optimizer would typically occur in absence of disclosure provided innovations/query optimization improvements.

More specifically, in step 215, a join column of a first table is determined. This join column is one that joins to a second table column per the join predicate of the RDMBS query (e.g., T1.Col1=T2.Col2). In step 220, a value for the join column (e.g., T1.Col1 and/or T2.Col2) can be determined that has a high skew. One of ordinary skill recognizes that the underlying table structure is considered when determining a “high skew” value in step 220. For example, in a sales database for a company that sells products in one hundred countries but sells fifty percent of products in the “United States” there would be a high skew. The construction of the able structure of the RDBMS can determine which of the tables is searched for the “high skew” at the join column. For example, if the RDBMS is in third normal form (3NF), T1.Col1 can be a primary key or a foreign key (values unique) for country code, in which case a high skew at the join would need to query T2.Col2 (where a sale may be unique, but duplicate records on the country code is permitted). In an opposite situation (where T1.C1 permits multiple records on country but where T2.Col2 does not permit duplication at this column) then the record count for skew purposes on the noted column would require a query of T1.Col1 instead of T2.Col2. If the both tables (T1 and T2) permit multiple records on the join predicate (T1.Col1 permits non-unique entries in this column and T2.Col2 permits non-unique entries in the join column) then a query for high skew would require some additional information, such as information acquired from table specific statistics. As tables are typically joined at indexed columns and as most databases are normalized, the above noted situation is uncommon, but can be accommodated in the disclosure as noted).

In step 225, a count RDBMS query (or an equivalent operation) can be performed to determine a quantity of records at the join predicate when a value (of the join column) is set to a high-skew value determined in step 220. For example, a SQL count query can be constructed for the second table (query local to the second table) where a value of the join (e.g., T2.Col2) is set to a fixed value (e.g., “United States”). In step 230, the count query is executed to produce query results. In step 235, the count query results are used to estimate a quantity of records for the join of the first and second tables per the join predicate. For example, the count from the count query can be equal to the estimated quantity of records. In one embodiment, the return from the count query can be weighted (multiplied by a constant) to alter a bias to a high-skew value (as this is an estimate since the value is established to a high skew value).

In step 240, if the quantity of records (estimated per step 235) is greater than a previously determined threshold, the process can continue to step 245, where the query optimizer can optimize the query per a first access path. This access path can be one optimized to handle a relatively large number of records (which has resulted from a high-skew, per the estimation technique). If the estimated quantity of records of step 240 does not exceed the previously established threshold, step 250 can execute where the query optimizer selects a second access path (optimized for a relatively low quantity of records resulting from the join predicate). In step 255, the RDBMS query can execute using the query optimizer determined access path (access path one or access path two depending on results from step 240 as shown).

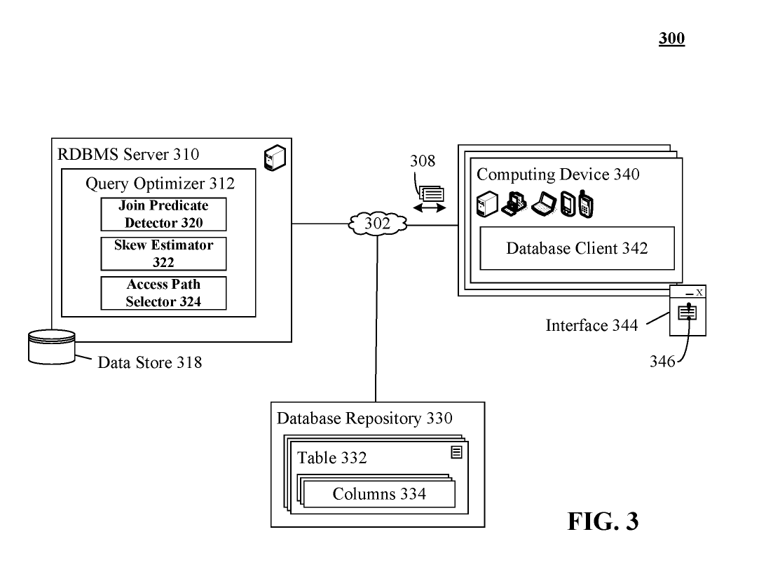

FIG. 3 shows a system 300 where query optimization sensitive to join skew in accordance with an embodiment of the disclosure. In system 300, a network 302 communicatively links one or more computing devices 340, an RDBMS server 310, and a database repository 330 of tables 330 maintained by server 310. The computing device 340 can generate a SQL query 308, which is conveyed over network 302 to RDBMS server 310. A query optimizer 312 of the RDBMS server 310 can optimize execution of query 308, as detailed herein.

The computing device 340 can include a database client 342, which permits a query item 344 to be input/selected through a graphical user interface 346. The submitted query 308 corresponds to the query item 344. The data repository 330 may be, but need not, be local to the RDBMS server 310. The data repository includes a set of tables 332, which include multiple columns 334. A set of records are stored in the repository 330 organized per the RDBMS structure of tables 332 and columns 334.

The query optimizer 310 includes a join predicate detector 320, a skew estimator 322, and an access path selector 324. Each of these (optimizer 312, 320, 322, 324) are structural components of the RDBMS server 310 defined to include a module of organized code as well as electronic circuitry, a processor, and one more non-transitory storage mediums holding programmatic instructions. Data store 318 can be one such non-transitory storage medium that stores programmatic instructions for structural components 312, 320, 322, 324 in one embodiment.

As used herein, RDBMS server 310 can be hardware/software structure (including electronic circuitry, processors, non-transitory storage, and programmatic instructions) that interacts with users, other applications, and/the database (repository 330) itself to capture and analyze data. The RDBMS server 310 can allow the definition, creation, querying, update, and administration of databases. The RDBMS server 310 can include MYSQL, POSGRESQL, MICROSOFT SQL SERVER, ORACLE, SYBASE, IBM DB2, and alternatives and derivatives of the same. Functions of the RDBMS server 310 allows management of database encoded data that includes data definition functions (creation, modification, removal of definitions that define the organization of data, update (insertion, modification, and deletion of organized data), retrieval (searching for stored organized information), and administration (registering and modifying user permissions, enforcing data security, maintaining data integrity, dealing with concurrency control, recovery functions, backup functions).

The query optimizer 312 is a structural unit including hardware/firmware/software used by an RDBMS server 310 to minimize an amount of time needed for executing RDBMS functions, such as SQL queries. The query optimizer 312 attempts to determine the most efficient way to execute a given query by considering the possible query plans (or alternative access paths). A query optimizer 312 recognizes that database structures are complex and that the needed data for a query can be collected from a database by accessing it in different ways, through different data-structures, and in different orders. Each different way typically requires different processing time. Processing times of the same query may have large variance, from a fraction of a second to hours, depending on the way selected. The purpose of query optimization, which is an automated process, is to find the way to process a given query in minimum time. The large possible variance in time justifies performing query optimization. The estimations performed in the disclosure approximates the optimum in a reasonable time (relatively low overhead of a one-time query optimization) to provide a “good enough” plan which typically does not deviate much from the best possible result. Specifically, the query optimizer 312 estimates selectivity across a predicate to pick a better plan than possible if this estimate were not performed.

The join predicate detector 320 detects a join predicate within a query that needs to be optimized. The first time a join occurs on a particular column across two tables, a onetime small overhead estimate for optimization purposes can be performed. The skew estimator 322 performs this estimate, and saves results in the data store 318 for future use by the query optimizer 312. In one embodiment, as records within the respective database repository 330 change over time, skew can change and the estimate for a join predicate can be re-executed. The access path selector 324 selects one of the query plans available to the query optimizer 312 given the estimate (which has estimated selectively of the join predicate). The access path or query plan as used herein represents an ordered set of steps used to access data in a SQL RDBMS (e.g., database repository 330 information).

Computing device 340 can be a hardware/software permitting data 308 interactions with the RDBMS server 310. Interactions can occur via user interactions through a database client 342 through a user interface 344. In embodiments, computing device 340 is a server, a desktop computer, mobile telephone, a tablet, an embedded computer, a notebook computer, a wearable computing device, and the like. Computing device 340 can include electronic circuitry, one or more processors, a non-transitory storage medium, program instructions stored in the medium and executed by the processors, firmware, and/or circuit encoded logic. The user interface 344 can be a graphical user interface, a voice user interface, a multimodal interface, and the like. The Database client 342 can be a stored software module that allows users to interact with RDBMS server 310 such as via a database connectively driver. In one embodiment, the database client 342 can provide a plug in architecture that allows plugins to modify application behavior to provide database-specific functionality or to provide features that are database independent. In one embodiment, a portion of the functionality shown in component 320, 322, 324 can be implemented within the database client 342.

Database repository 330 can be a hardware/software entity able to persist data, which includes data for tables 332, table columns 334, records, and join predicate estimate date. In one instance, repository 330 can be a shared file storage repository including, but not limited to, a cloud based storage, a local area network accessible storage, and the like. Access to database records and data within the database repository 330 can require authentication, such as a user name/password. The database repository 330 can be maintained independent of the RDBMS server 310, and can be remotely located (and require separate permission) from any messaging system (through which information is conveyed).

Network 302 can each be an electrical and/or computer network connecting one or more system 300 components. Network 302 can include, but is not limited to, twisted pair cabling, optical fiber, coaxial cable, and the like. Network 302 can include any combination of wired and/or wireless components. Network 302 topologies can include, but is not limited to, bus, star, mesh, and the like. Network 302 types can include, but is not limited to, Local Area Network (LAN), Wide Area Network (WAN), Virtual Private Network (VPN) and the like.

Drawings presented herein are for illustrative purposes only and should not be construed to limit the invention in any regard. It should be appreciated that one or more components within system 100/300 can be optional components permitting that the disclosure functionality be retained. Further, the flowchart of FIG. 2 and system diagram of FIG. 3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for skew-sensitive query optimization across join predicates in a relational database management system (RDMBS) comprising:
receiving, at a query optimizer comprising hardware and software, a relational database management system (RDBMS) query having a join predicate with a join between a first and a second table, wherein a cardinality of resulting rows from the join predicate is unknown to the query optimizer triggering default behavior in absence of join predicate skew information, which is initially lacking;
determining, at the query optimizer, a high skew value for a first variable joining the first and second tables at columns per the join predicate;
automatically constructing and running a count query on one of the first and second tables only using the high skew value as a substitution for the first variable;
estimating a quantity of records for the join of the first and second tables using results of the count query;
if the estimated quantity of records is greater than a previously determined threshold, optimizing, at the query optimizer, the RDBMS query using a first access path; and
if the estimated quantity of records is not greater than the previously determined threshold, optimizing, at the query optimizer, the RDBMS query using a second access path,
wherein the first access path and the second access path produce functionally equivalent results while having disparate computational speeds to produce the equivalent results, wherein an access path used by the query optimizer responsive to comparing the estimated quantity of records to the previously determined threshold is computationally faster than the default behavior.
